(19) United States
(12) Patent Application Publication
(10) Pub. No.: US 2025/0376289 A1
(43) Pub. Date: Dec. 11, 2025

(54) CONTAINER HAVING AN UNDULATING BASE, AND MOLD BASE FOR MANUFACTURING THE SAME

(71) Applicant: SIDEL PARTICIPATIONS, Octeville-sur-Mer (FR)

(72) Inventor: Michel BOUKOBZA, OCTEVILLE-SUR-MER (FR)

(21) Appl. No.: 19/203,722

(22) Filed: May 9, 2025

(30) Foreign Application Priority Data
Jun. 6, 2024 (FR) FR2405975

(51) Int. Cl. B65D 1/02; B29C 49/48; B29K 67/00; B29L 31/00

(52) U.S. Cl. CPC B65D 1/0284; B29C 49/4802; B29K 2067/003; B29L 2031/7158; B65D 2501/0036

(57) ABSTRACT

Provided is a container made from plastic and provided with a body and a base extending from a lower end of the body. The base includes at least one peripheral heel defining a seat and an arch that extends from a central zone to the heel, the heel rising up a connecting wall connecting with the wall of the body of the container. The base has a plurality of radial undulations extending from at least the central zone to the vicinity of the seat, extending in the arch. The undulations have a concave face and a convex face facing outward, the depth between the peak of a convexity and the trough of a concavity, of said undulations increasing from the central zone to the vicinity of the seat. Also described is a mold base for manufacturing such a container.

### CROSS-REFERENCE TO RELATED APPLICATIONS

This application claims the benefit of French Application No. FR 2405975, filed Jun. 6, 2024, the entire contents of which is hereby incorporated herein by reference.

### BACKGROUND

It is well known that containers intended to contain a still liquid (for example, bottles intended to contain table water) are, in most cases, provided with a domed base in the general shape of a spherical cap having a concavity facing outward and having a relatively small height.

The bases of these containers are usually provided with ribs that radiate substantially radially and are distributed around a central indentation, wherein said ribs can have various forms and can optionally extend onto the bottom of the wall of the body in order to reinforce the seat (peripheral zone by means of which the base rests on a surface).

Such bases are formed to support the column of still liquid above them without deformation. However, they are not sufficiently strong to withstand an additional stress, which can for example be due to internal excess pressure, even of low value.

It is known practice, during the bottling of certain easily oxidized liquids such as oil or fruit juices in particular, to pour a small quantity of liquid, such as a drop of a rapidly vaporizing inert substance, usually nitrogen, onto the surface of the still liquid at the end of the container filling phase in order to evacuate the air, and therefore the oxygen contained therein, from the free space above the liquid surface immediately before the capping of the container, in an operation known as “inerting” or “nitrogen sparging”, in order for example to reinforce lighter bottles for still water.

This small quantity of inert substance finishes vaporizing once capping is complete, so that inerting gas remains in the closed container at a low residual pressure of less than 1.5×10⁵ Pa, typically of the order of 0.8×10⁵ Pa, or even of the order of 0.5×10⁵ Pa.

However, the slightly domed bases conventionally provided for containers intended for still liquids are not able to withstand with certainty, without deformation, a pressure even as low as that caused by the inerting process.

In order to overcome this drawback, it is well known, for containers the contents of which must undergo an inerting process, to provide them with improved bases in terms of strength so that they do not deform under the action of the internal excess pressure.

A reinforced base of this type usually comprises an arch having a generally domed shape having a concavity facing toward the outside of the container, and has an annular zone surrounding the arch and forming a substantially flat seat by means of which said base can rest stably on a flat surface. In its central part, the arch opens onto a curved dome also having a concavity facing outward, said dome therefore being situated set back toward the inside of the container relative to the arch. Outside the annular zone that forms a seat, the base has a return wall, also known as the connecting wall, connecting with the wall of the body of the container. A plurality of main ribs opening outward, in the general form of channels with substantially parallel edges and a substantially constant depth, extend radially in a star shape from the return wall of the base to the dome in which they end, passing through the annular zone forming a seat and the arch, the number of main ribs usually being odd, generally equal to five.

Furthermore, in order to improve the mechanical strength of the base, secondary ribs are generally added, which can have substantially the same form as the main ribs and are interposed between the main ribs, but extend radially in a star shape from the return wall of the base only to the middle of the arch, passing through the annular zone forming a seat. It will be noted that all of the ribs, both the main ribs and the secondary ribs, are recessed in the arch, which has a smooth annular form that is only indented by the ribs.

The manufacturers of thermoplastic containers are continuously seeking to make the containers lighter, which is achieved, inter alia, by reducing the weight of the bases of the containers.

Container bases having shapes that were initially satisfactory are therefore no longer suitable due to the significant reduction in the quantity of material used. Experience has thus shown that a reinforced base arranged as described above is no longer satisfactory, in the lighter version, even for excess pressures of only around 0.5×10⁵ Pa.

Additionally, due to increasingly high production rates, the continuous and ultimately random injection of the quantity of inerting liquid, and the variations in the free space between the liquid and the lip of the containers, the volume of inerting liquid can vary very considerably, causing variations in pressure of plus or minus 0.2 bar for a target pressure of 0.6 bar, i.e. a pressure variation of approximately 30%.

In these conditions, the aforementioned bases, in their lighter version, are not therefore able to withstand, with certainty, such an excess pressure without collapsing.

In order to overcome these drawbacks, containers provided with a reinforced base have already been devised. This is the case of documents FR 2 883 550 and FR 2932458 in particular.

Said document FR 2 883 550 describes a container the base of which comprises a double structure of domed panels, both with respect to the panels defined between the protruding impressions in the base of the container itself and with respect to the arches of said impressions. A double buttressing system on two levels is thus formed and, although it is not capable of withstanding high pressures, it is however able to withstand without significant deformation a relatively low residual pressure not in excess of approximately 0.5×10⁵ Pa such as that remaining after an inerting operation.

However, the manufacturing of this type of container requires a large quantity of thermoplastic material, which does not make it possible to obtain the lighter version usually required by manufacturers.

Document FR 2932458 describes a container, in particular a bottle, made from a thermoplastic material such as PET, having a body extending between, at the top, a neck, and at the bottom, a base able to withstand without marked deformation the excess pressure caused by an inerting operation not in excess of approximately 2×10⁵ Pa. Said base comprises a concave arch having a concavity facing toward the outside of the container, a dome protruding toward the inside of the container and having a concavity facing outward, opening at the center of said arch, an annular zone surrounding the base of said arch and forming a substantially flat seat by which said base can rest stably on a flat surface, and ribs in the form of grooves opening outward, extending substantially radially through said annular zone forming a seat and rising up the connecting wall connecting with the wall of the body of the container. Said base also comprises claw-shaped zones, separated from each other, which extend the bottom of the body radially in the direction of the central axis of the base and are offset protruding outward relative to said arch, and radial grooves delimited between said claw-shaped zones, said grooves having bottoms formed by radial sections of said arch and having a radially variable depth which is at a maximum approximately in correspondence with said annular zone forming a seat.

None of these types of container can be filled with still liquids and closed in the presence of a relatively low pressure, in principle of the order of 0.5×10⁵ Pa and in practice not exceeding 1×10⁵ Pa, when said containers are obtained from recycled PET, referred to as rPET, said rPET having different mechanical properties from PET, such that the bases of these containers do not have sufficient impact resistance.

The present disclosure is directed at solving these problems.

### SUMMARY

The present disclosure relates to the field of containers, in particular bottles or pots, manufactured by blow-molding or stretch blow-molding of blanks made from a plastic material such as polyethylene terephthalate (PET), and more particularly of blanks fully or partially obtained from recycled polyethylene terephthalate (rP ET).

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is a perspective bottom view of a plastic container according to various example embodiments;

FIG. 2 is a perspective bottom view of the base of a plastic container according to various example embodiments;

FIG. 3 is a bottom view of the base of a plastic container according to various example embodiments;

FIG. 4 is a side view of the base of the plastic container shown in FIGS. 1 to 3;

FIG. 5 is a cutaway perspective bottom view of the base of the plastic container shown in FIGS. 1 to 4;

FIG. 6 is a cutaway perspective top view of the base of the plastic container shown in FIGS. 1 to 5;

FIG. 7 is a radial cross-sectional view of the base of the plastic container shown in FIGS. 1 to 6;

FIG. 8, is a perspective bottom view of a variant embodiment of the plastic container;

FIG. 9 is a perspective bottom view of the base of the variant embodiment of the container shown in FIG. 9;

FIG. 10 is a bottom view of the base of the variant embodiment of the container shown in FIGS. 8 and 9;

FIG. 11 is a radial cross-sectional view of the base of the variant embodiment of the plastic container shown in FIGS. 8 to 10;

FIG. 12 is an exploded perspective view of a mold, including a mold base, for manufacturing a container according to various example embodiments;

FIG. 13 is a perspective top view of a mold base for obtaining a container shown in FIGS. 1 to 7;

FIG. 14 is a top view of the mold base for obtaining a container shown in FIGS. 1 to 7;

FIG. 15 is a radial cross-sectional view of the mold base shown in FIGS. 13 and 14;

FIG. 16 is a perspective top view of a variant embodiment of a mold base for obtaining a container shown in FIGS. 8 to 11;

FIG. 17 is a perspective top view of the variant embodiment of the mold base shown in FIG. 16; and

FIG. 18 is a radial cross-sectional view of the variant embodiment of the mold base shown in FIG. 16.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

### General Discussion

In accordance with the purpose(s) of the present disclosure, as embodied and broadly described herein, embodiments of the present disclosure, in some aspects, relate to overcoming overcome all or some of the aforementioned drawbacks by proposing a container having a simple, low-cost design, obtained from recycled PET, referred to as rPET, capable of being filled with still liquids and closed in the presence of a relatively low pressure, in principle of the order of 0.5×10⁵ Pa and in practice not exceeding 1×10⁵ Pa, that only requires a minimum quantity of thermoplastic material, is easy to form correctly in normal conditions for blow-molding or stretch blow-molding containers intended to still liquids, has good impact resistance, and has a height of substantially the same order of magnitude as the height of the bases of conventional containers for still liquids.

To this end, and according to the disclosure, a plastic container is proposed that is provided with a body and a base extending from a lower end of the body, said body comprising, at its upper end, a shoulder and a neck, and the base comprising at least one peripheral heel defining a seat, and an arch that extends from a central zone to said heel, said heel rising up a connecting wall connecting with the wall of the body of the container, notable in that said base comprises a plurality of radial undulations with continuity of tangency extending from at least the central zone to the vicinity of the seat, i.e. extending in the arch, an undulation being made up of a concave face and a convex face facing outward, the depth, that is the distance between the peak of a convexity and the trough of a concavity, of said undulations increasing from the central zone to the vicinity of the seat.

Preferably, the radial undulations have continuity of tangency.

Alternatively, said radial undulations can comprise at least one facet, each facet extending radially or extending perpendicularly to a radius of the base, and each facet being able to be flat or recessed or protruding and being able to have any shape.

Preferably, the mean radius of curvature of the concavities of the undulations is less than or equal to the mean radius of curvature of the convexities of the undulations.

Furthermore, the mean radius of curvature of the concavities of the undulations is between 0.5 and 1.1 times the mean radius of curvature of the convexities of the undulations.

Preferably, said mean radius of curvature of the concavities of the undulations is between 0.65 and 0.85 times the mean radius of curvature of the convexities of the undulations.

Furthermore, the mean radius of curvature of the concavities and/or of the convexities of the undulations is not constant along a radius of the base, from the central zone toward the seating plane.

In addition, the base comprises between five and fifteen radial undulations with continuity of tangency, and preferably between eight and ten radial undulations with continuity of tangency.

Preferably, the height of the arch, i.e. the distance separating the seating plane from the upper end of the arch, is between 0.15 and 0.35 times the diameter of the seat.

Preferably, the height of the arch is between 0.2 and 0.25 the diameter of the seat, and preferably equal to 0.228 times the diameter of the seat.

Furthermore, the depth of an undulation in the seating plane is between 0.2 and 0.45 times the height of the arch.

In addition, the depth of an undulation in the central zone is between 0.03 and 0.15 times the height the arch.

In addition, between the central zone and the seating plane, the depth of an undulation is between 0.2 and 0.45 times the height the arch.

According to one variant embodiment, said undulations extend beyond the seat.

According to one variant embodiment, the concave face of the undulations extends beyond the seat and the convex face of the undulations extends from the central zone to the vicinity of the seat.

Furthermore, the so-called outer radius of curvature of the heel, i.e. the radius of curvature of the heel between the seat and the connecting wall, is between 0.07 and 0.2 times the seat diameter, and preferably equal to 0.13 times the seat diameter.

In addition, the so-called inner radius of curvature of the heel, i.e. the radius of curvature of the heel between the distal end of the convex face of the undulations and the seat, is between 0.6 and 1.4 times the outer radius of curvature of said heel, and preferably equal to 0.92 times the outer radius of curvature of said heel.

Furthermore, the height of the arch, i.e. the distance separating the central zone from the seating plane, is between 0.2 and 0.4 times the diameter of the seat.

In addition, the width of the seat is between 0.1 and 2 mm, and preferably equal to 0.5 mm.

Another object of the disclosure relates to a mold base for manufacturing a container as described herein from a plastic preform, said mold base being capable of being mounted at one end of a mold comprising two walls that can be moved relative to each other and are intended to form the body of the container, said mold base comprising at least one first annular part intended to at least partially form the heel, i.e. the seating plane, and a second dome-shaped part intended to come into contact with an amorphous central zone of the preform to form the arch, or comprising a base ring making it possible to form the heel of the container and an arch piece that is inserted into said base ring; said mold base is notable in that said second part or the arch piece comprises a plurality of radial undulations extending from at least one central zone to the first annular part or to the base ring, i.e. extending at least in the second dome-shaped part, the depth, that is the distance between the peak of a convexity and the trough of a concavity, of said undulations increasing from the central zone to the periphery of the second part or to the base ring.

Preferably, the mean radius of curvature of the concavities of the undulations is less than or equal to the mean radius of curvature of the convexities of the undulations.

Furthermore, the mean radius of curvature of the concavities of the undulations is between 0.5 and 1.1 times the mean radius of curvature of the convexities of the undulations, and preferably between 0.65 and 0.85 times the mean radius of curvature of the convexities of the undulations.

In addition, the mean radius of curvature of the concavities and/or of the convexities of the undulations is not constant along a radius of the base of the mold base, from the central zone toward the periphery of the second part or to the base ring.

Preferably, the mold base comprises between three and fifteen radial undulations with continuity of tangency, and preferably between eight and ten radial undulations with continuity of tangency.

Turning now to the drawings, exemplary embodiments are described in detail.

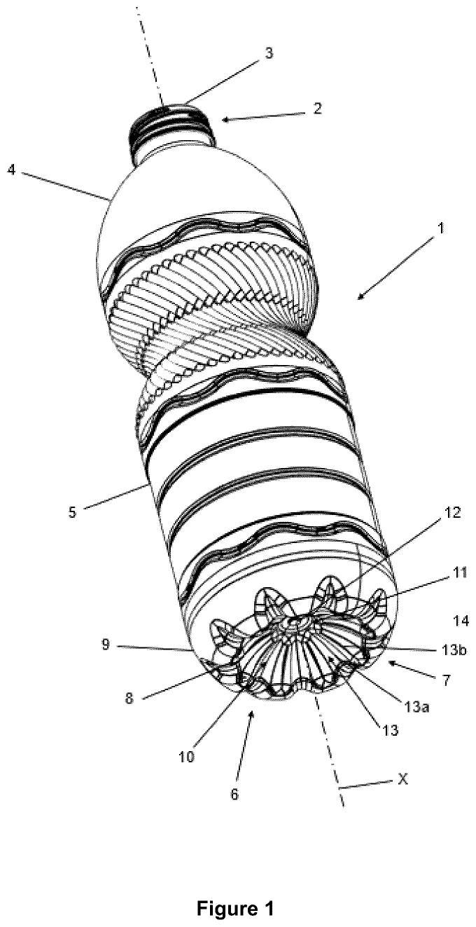

With reference to FIG. 1, the container 1 consists, in this instance, of a bottle produced by stretch blow-molding from a preform made from a thermoplastic material, for example PET (polyethylene terephthalate) and/or rPET (recycled polyethylene terephthalate), or similar.

Said container 1 comprises, at an upper end, a neck 2, provided with a lip 3. Continuing from the neck 2, in the direction of the lower end of the container 1, said container comprises, as is usual, in its upper part, a shoulder 4 that flares in the opposite direction to the neck 2, this shoulder 4 being extended by a side wall or body 5, of generally cylindrical shape having an axis of revolution about a vertical longitudinal axis X, shown in dashed lines, of the container 1.

The container 1 further comprises a base 6 that extends at the opposite end from the neck 2, from a lower end of the body 5. Said base 6 comprises a peripheral heel 7 in the form of an annular bead that extends substantially axially in the continuation of the body 5. The heel 7 ends in a seating plane 8, also referred to as the seat, perpendicular to the longitudinal axis X of the container 1, said seating plane 8 defining the lower end of the container 1 and allowing the container 1 to be placed, vertically, on a flat surface. In addition, said heel 7 rises up a so-called connecting wall 9 connecting with the wall of the body 5 of the container 1.

The diameter of the seating plane 8 is denoted D1, the term “diameter” covering not only the situation (illustrated) in which the container 1 (and therefore the base 6) has a circular outline, but also the situation in which the container 1 has a polygonal (for example square) outline, in which case the term “diameter” denotes the diameter of the circle in which said polygon is inscribed, without departing from the scope of the invention.

Furthermore, the base 6 also comprises a concave arch 10, in the form of a substantially spherical cap having a concavity facing toward the outside of the container 1 in the absence of stress, that is in the absence of contents in the container 1. The arch 10 extends from the heel 7 to a central zone 11 of the base 6 forming a slug protruding toward the inside of the container 1, with an amorphous pellet 12 at its center that corresponds to the injection zone of the material forming the preform used to produce the container and can perform a centering function during the forming of the container 1 by blow-molding.

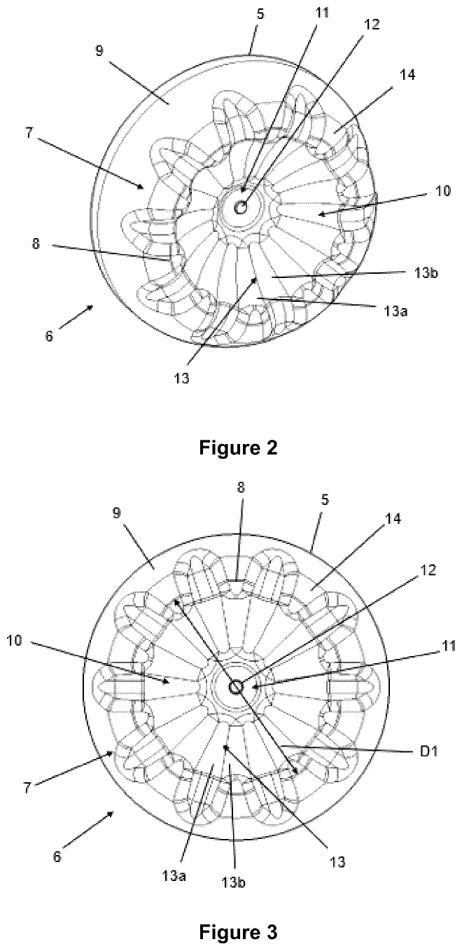

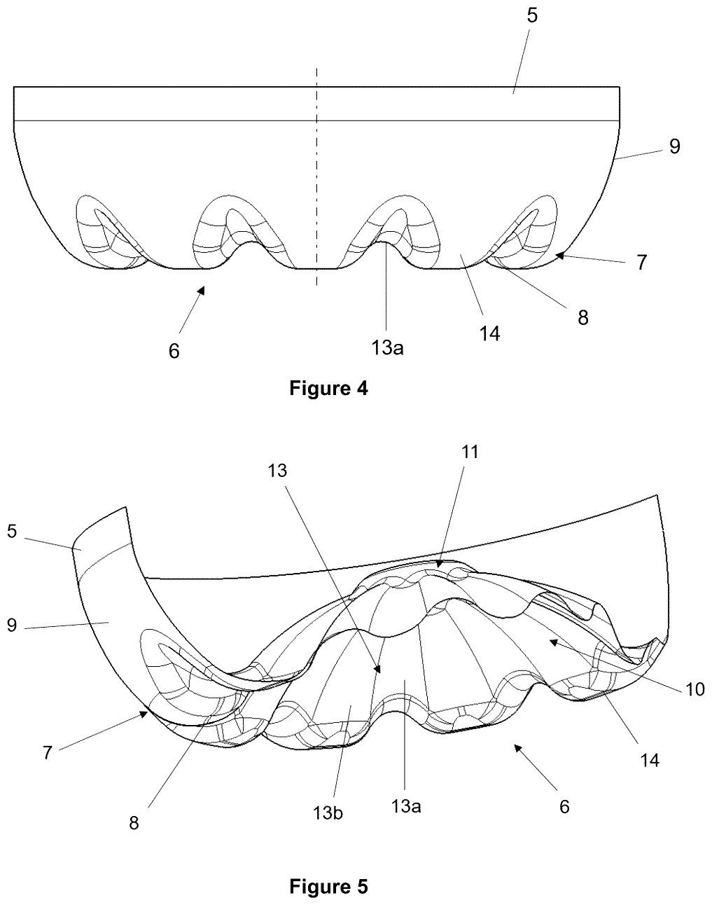

In addition, with reference to FIGS. 1 to 6, said base 6 comprises a plurality of radial undulations 13 with continuity of tangency extending from at least the central zone 11 to the vicinity of the heel 7, i.e. extending in the arch 10, an undulation 13 being made up of a concave face 13a and a convex face 13b facing outward, the depth, that is the distance between the peak of a convexity and the trough of a concavity, of said undulations 13 increasing from the central zone 10 to the vicinity of the heel 7.

It is obvious that said radial undulations 13 can be without continuity of tangency and comprise, for example, one or more facets, of any shape, flat and/or recessed and/or protruding, and extending radially or perpendicularly to a radius of the base 6, without departing from the scope of the invention.

In this first variant embodiment of the container, the concave face 13a of the undulations 13 extends beyond the seat 8 and the convex face 13b of the undulations 13 extends from the central zone to the vicinity of the seat 8. “The vicinity of the seat” is given to mean a few millimeters before the seat 8. Thus, in this variant embodiment, the convex face 13b of the undulations 13 extends onto the connecting wall, forming feet 14 on the seat 8, which is thus discontinuous.

Preferably, the mean radius of curvature of the concavities of the undulations 13 is less than or equal to the mean radius of curvature of the convexities of said undulations 13. More specifically, the mean radius of curvature of the concavities of the undulations 13 is between 0.5 and 1.1 times the mean radius of curvature of the convexities of the undulations 13. It will be noted that “convexities of the undulations” is given to mean the convex faces 13b of said undulations.

Furthermore, said mean radius of curvature of the concavities of the undulations 13 is between 0.65 and 0.85 times the mean radius of curvature of the convexities of the undulations 13. It will be noted that “concavities of the undulations” is given to mean the concave faces 13a of said undulations.

Furthermore, the mean radius of curvature of the concavities and/or of the convexities of the undulations 13 is not constant along a radius of the base 6, from the central zone 11 toward the seat 8.

In this particular exemplary embodiment, the base 6 comprises ten radial undulations 13 with continuity of tangency. However, depending on the dimensions of the container and/or the application of said container, said base 6 can comprise between five and fifteen radial undulations with continuity of tangency, and preferably between eight and ten radial undulations with continuity of tangency.

Furthermore, the height of the arch 10, i.e. the distance separating the seating plane from the upper end of the arch 10, is preferably between 0.15 and 0.35 times the diameter D1 of the seat 8. Preferably, the height of the arch 10 is between 0.2 and 0.25 times the diameter D1 of the seat 8, and preferably equal to 0.228 times the diameter D1 of the seat 8.

Advantageously, the depth of an undulation 13 in the seating plane, that is, the distance between the peak of a convexity 13b and the trough of a concavity 13a, is preferably between 0.2 and 0.45 times the height of the arch 10.

In addition, the depth of an undulation in the central zone is between 0.03 and 0.15 times the height the arch.

In addition, between the central zone 11 and the seating plane, the depth of an undulation is between 0.2 and 0.45 times the height the arch 10.

Advantageously, the so-called outer radius of curvature of the heel, i.e. the radius of curvature of the heel between the seat and the connecting wall, is between 0.07 and 0.2 times the seat diameter, and preferably equal to 0.13 times the seat diameter.

In addition, the so-called inner radius of curvature of the heel 7, i.e. the radius of curvature of the heel 7 between the distal end of the convex face 13b of the undulations 13 and the seat 8, is between 0.6 and 1.4 times the outer radius of curvature of said heel 7, and preferably equal to 0.92 times the outer radius of curvature of said heel 7.

Furthermore, the height of the arch 10, i.e. the distance separating the central zone 11 from the seating plane, is between 0.2 and 0.4 times the diameter D1 of the seat, the width of the seat being between 0.1 and 2 mm, and preferably equal to 0.5 mm.

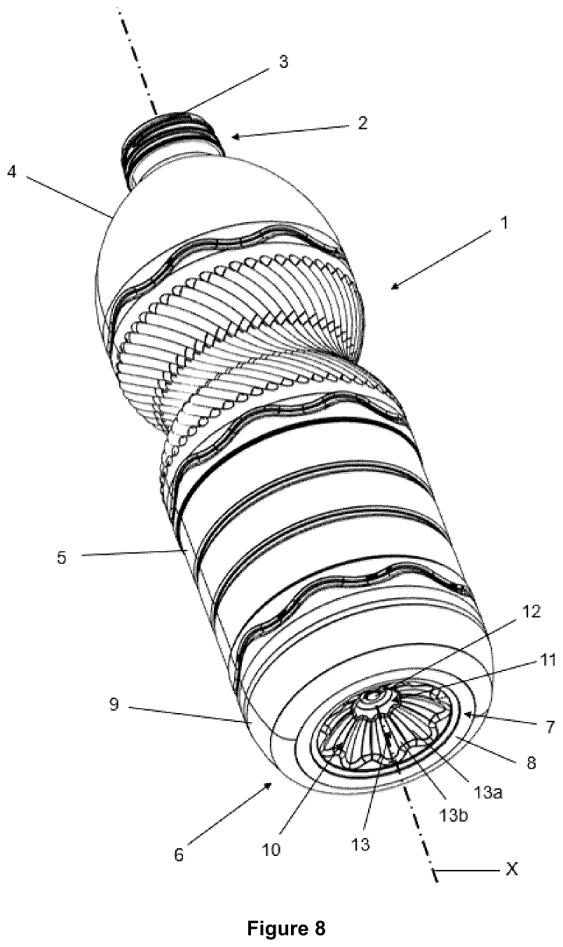

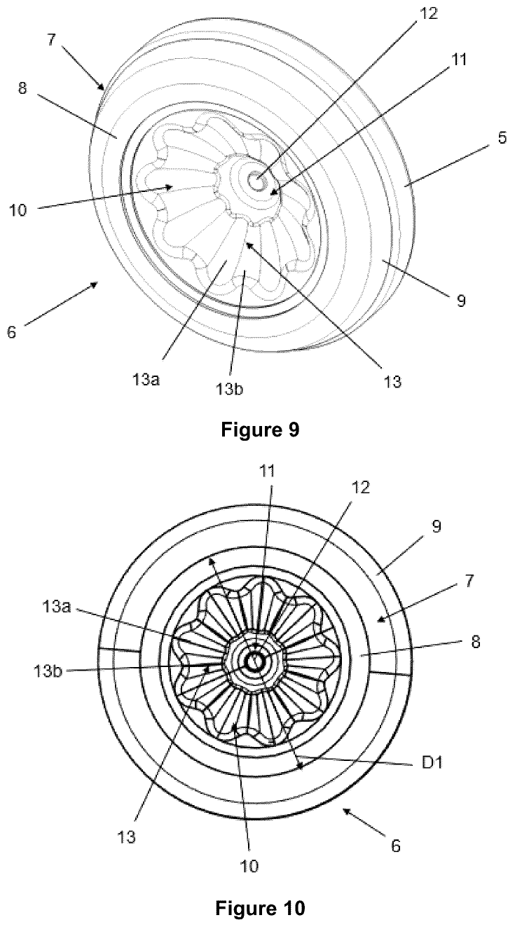

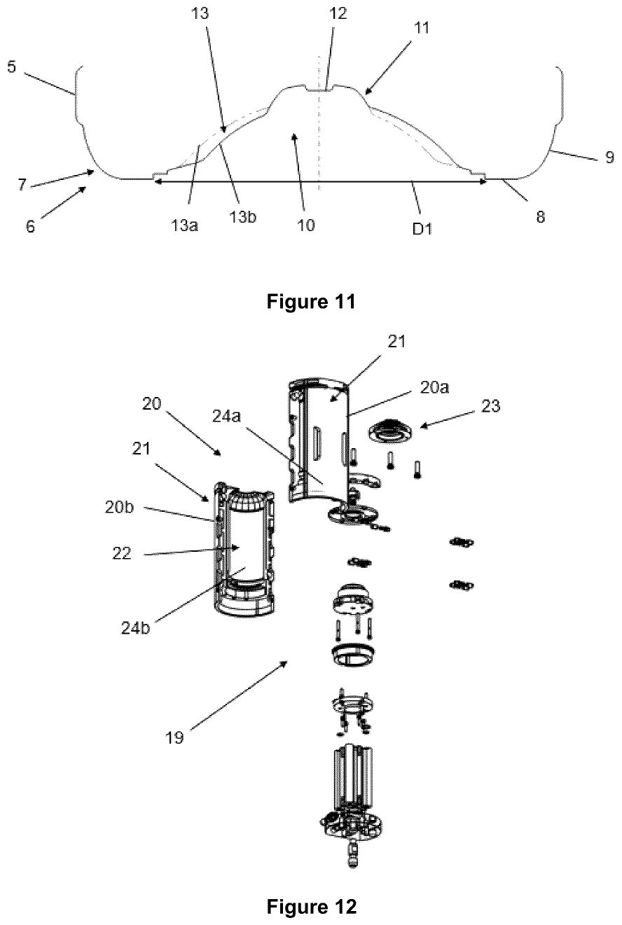

According to a second variant embodiment of the container, with reference to FIGS. 8 to 11, the container 1 consists, as above, of a bottle produced by stretch blow-molding from a preform made from a thermoplastic material, for example PET (polyethylene terephthalate) and/or rPET (recycled polyethylene terephthalate), or similar.

Said container 1 comprises, at an upper end, a neck 2, provided with a lip 3. Continuing from the neck 2, in the direction of the lower end of the container 1, said container comprises, as is usual, in its upper part, a shoulder 4 that flares in the opposite direction to the neck 2, this shoulder 4 being extended by a side wall or body 5, of generally cylindrical shape having an axis of revolution about a vertical longitudinal axis X, shown in dashed lines, of the container 1.

The container 1 further comprises a base 6 that extends at the opposite end from the neck 2, from a lower end of the body 5. Said base 6 comprises a peripheral heel 7 in the form of an annular bead that extends substantially axially in the continuation of the body 5. The heel 7 ends in a seating plane 8, also referred to as the seat, perpendicular to the longitudinal axis X of the container 1, said seat 8 defining the lower end of the container 1 and allowing the container 1 to be placed, vertically, on a flat surface. In addition, said heel 7 rises up a so-called connecting wall 9 connecting with the wall of the body 5 of the container 1.

The diameter of the seating plane 8 is denoted D1, the term “diameter” covering not only the situation (illustrated) in which the container 1 (and therefore the base 6) has a circular outline, but also the situation in which the container 1 has a polygonal (for example square) outline, in which case the term “diameter” denotes the diameter of the circle in which said polygon is inscribed, without departing from the scope of the invention.

Furthermore, the base 6 also comprises a concave arch 10, in the form of a substantially spherical cap having a concavity facing toward the outside of the container 1 in the absence of stress, that is in the absence of contents in the container 1. The arch 10 extends from the heel 7 to a central zone 11 of the base 6 forming a slug protruding toward the inside of the container 1, with an amorphous pellet 12 at its center that corresponds to the injection zone of the material forming the preform used to produce the container and can perform a centering function during the forming of the container 1 by blow-molding.

In addition, with reference to FIGS. 8 to 11, said base 6 comprises a plurality of radial undulations 13 with continuity of tangency extending from at least the central zone 11 to the vicinity of the seat 8, i.e. extending in the arch 10, an undulation 13 being made up of a concave face 13a and a convex face 13b facing outward, the depth, that is the distance between the peak of a convexity and the trough of a concavity, of said undulations 13 increasing from the central zone 10 to the vicinity of the seat 8.

In this second variant embodiment of the container, the concave face 13a and the convex face 13b of the undulations 13 extends from the central zone 11 to the vicinity of the seat 8. “The vicinity of the seat” is given to mean a few millimeters before the seat 8. Unlike in the preceding variant embodiment, the base 6 thus does not comprise feet on the seat 8, the seat 8 thus being continuous.

As above, the mean radius of curvature of the concavities of the undulations 13 is preferably less than or equal to the mean radius of curvature of the convexities of said undulations 13. More specifically, the mean radius of curvature of the concavities of the undulations 13 is between 0.5 and 1.1 times the mean radius of curvature of the convexities of the undulations 13. It will be noted that “convexities of the undulations” is given to mean the convex faces 13b of said undulations.

Furthermore, said mean radius of curvature of the concavities of the undulations 13 is between 0.65 and 0.85 times the mean radius of curvature of the convexities of the undulations 13. It will be noted that “concavities of the undulations” is given to mean the concave faces 13a of said undulations.

Furthermore, the mean radius of curvature of the concavities and/or of the convexities of the undulations 13 is not constant along a radius of the base 6, from the central zone 11 toward the seat 8.

In this particular exemplary embodiment, the base 6 comprises nine radial undulations 13 with continuity of tangency. However, depending on the dimensions of the container and/or the application of said container, said base 6 can comprise between five and fifteen radial undulations with continuity of tangency, and preferably between eight and ten radial undulations with continuity of tangency.

Furthermore, the height of the arch 10, i.e. the distance separating the seating plane from the upper end of the arch 10, is preferably between 0.15 and 0.35 times the diameter D1 of the seat 8. Preferably, the height of the arch 10 is between 0.2 and 0.25 times the diameter D1 of the seat 8, and preferably equal to 0.228 times the diameter D1 of the seat 8.

In addition, between the central zone 11 and the seating plane, the depth of an undulation is between 0.2 and 0.45 times the height the arch 10.

Finally, the height of the arch 10, i.e. the distance separating the central zone 11 from the seating plane, is between 0.2 and 0.4 times the diameter D1 of the seat, the width of the seat being between 0.1 and 2 mm, and preferably equal to 0.5 mm.

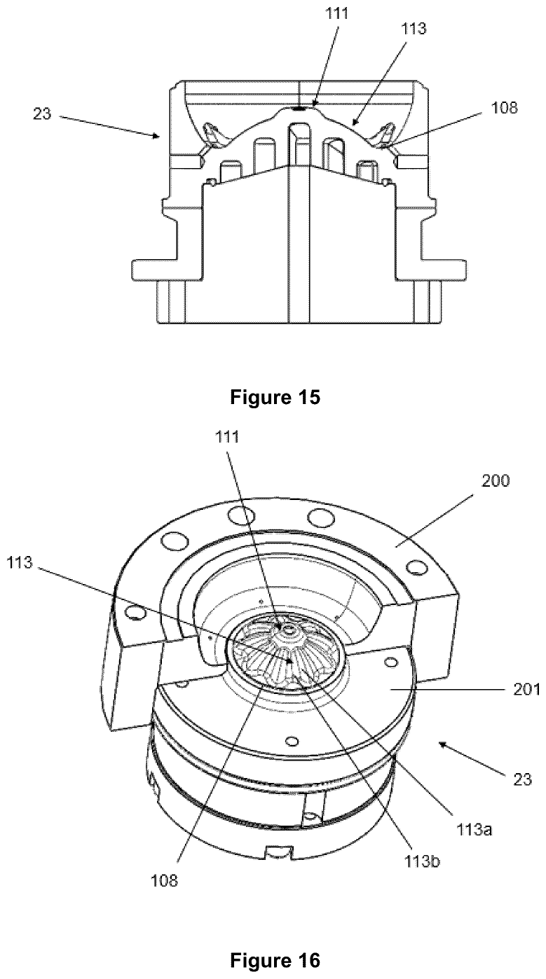

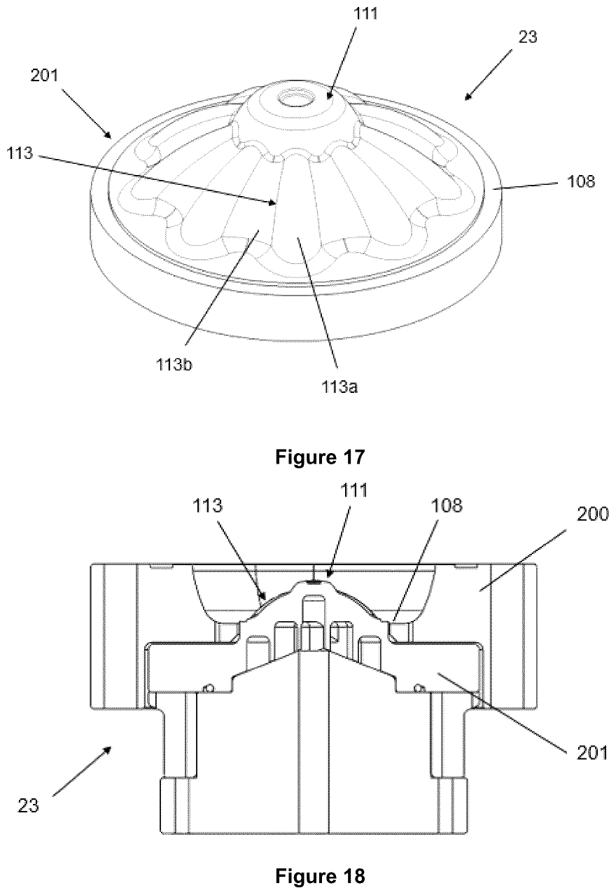

With reference to FIGS. 12 to 18, a molding unit 19 is described for forming, from a blank, typically a preform, of a container according to the disclosure, such as a bottle or flask.

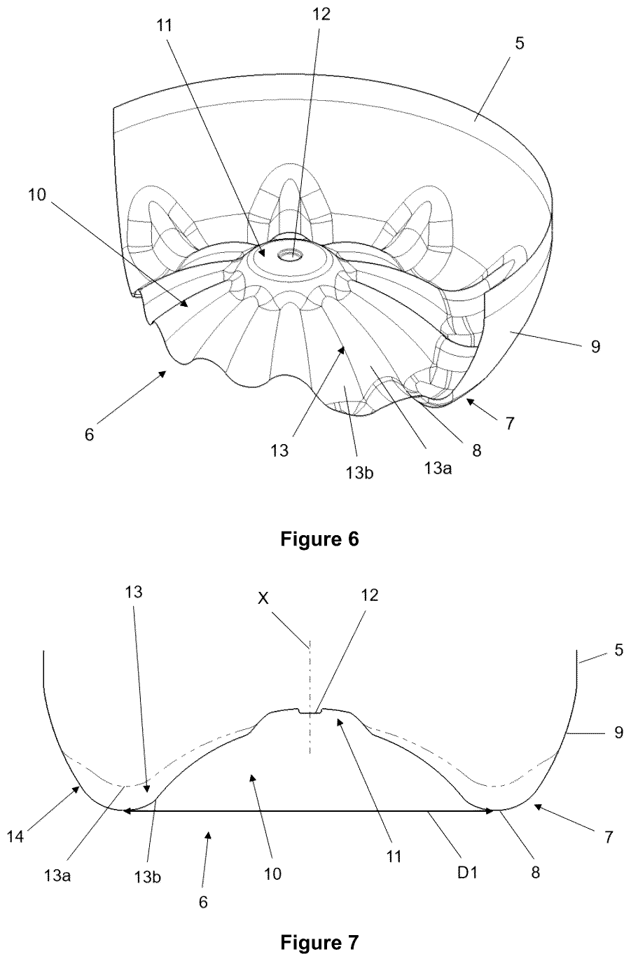

With reference to FIG. 12, said molding unit 19 comprises a mold 20 provided with a lateral wall 21 that defines a cavity 22 having an impression of part of the container. Said mold 20 further comprises a base 23 having an impression of the base of the container, said mold 20 being made from metal, for example steel or aluminum (this term also covers aluminum alloys). The cavity 22 and ultimately the mold 20 extends along a main axis X that defines a vertical direction. Any plane perpendicular to the main axis X is referred to as horizontal. According to one embodiment illustrated in the drawings, the lateral wall 21 comprises two half-molds 20A, 20B each defining a half-impression 24A, 24B of the body of the container and rotatably mounted relative to each other about a common axis formed by a hinge, not shown in the Figures, between an open position, in which the half-molds 20A, 20B are angularly separated from each other and the mold base 23 is lowered relative to the half-molds 20A, 20B to allow the insertion of the blank and the removal of the formed container, and a closed position, in which the half-molds 20A, 20B are applied against each other and trap the mold base 23 between them, as shown in FIGS. 6 to 8, to thus form the cavity 22 and define the impression of the container to be formed. Said mold base 23 is thus capable of being movably mounted in the mold 20 comprising two walls that can be moved relative to each other and are intended to form the body of the container.

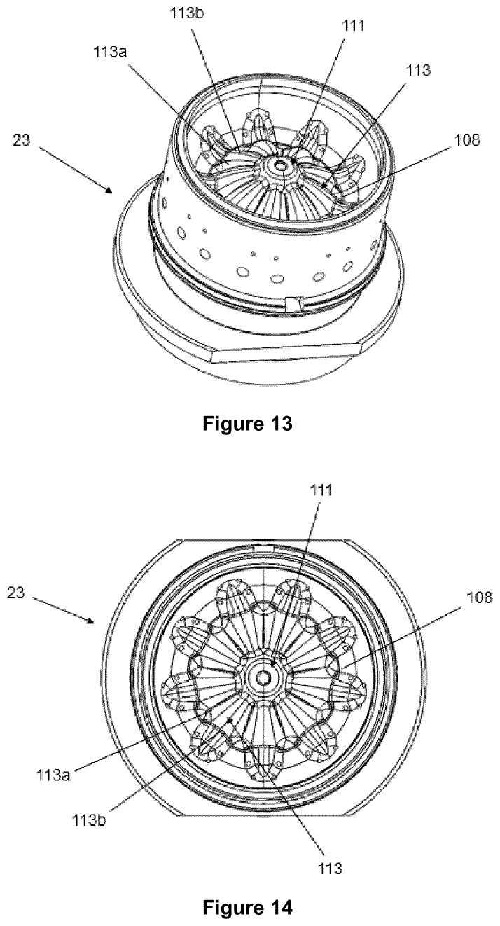

With reference to FIGS. 13 to 15, in order to manufacture a container shown in FIGS. 1 to 7, said mold base 23 comprises a plurality of radial undulations 113 with continuity of tangency extending from a central zone 111 to the vicinity of a seat 108, i.e. extending in an arch 110, an undulation 113 being made up of a concave face 113a and a convex face 113b facing outward, the depth, that is the distance between the peak of a convexity and the trough of a concavity, of said undulations increasing from the central zone 111 to the vicinity of the seat 108.

Preferably, the mean radius of curvature of the concavities of the undulations 113 is less than or equal to the mean radius of curvature of the convexities of the undulations 113.

Furthermore, the mean radius of curvature of the concavities 113a of the undulations is between 0.5 and 1.1 times the mean radius of curvature of the convexities 113b of the undulations, and preferably between 0.65 and 0.85 times the mean radius of curvature of the convexities 113b of the undulations 113.

In addition, the mean radius of curvature of the concavities 113a and/or of the convexities 113b of the undulations 113 is not constant along a radius of the base of the mold base 23, from the central zone 111 toward the periphery of the seat 108.

Preferably, the mold base 23 comprises between five and fifteen radial undulations 113 with continuity of tangency, and preferably between eight and ten radial undulations 113 with continuity of tangency.

According to one variant embodiment, with reference to FIGS. 16 to 18, in order to manufacture a container as shown in FIGS. 8 to 11, said mold base 23 is made up of a base ring 200 making it possible to form the heel of the container and an arch piece 201 that is inserted into said base ring 200. Said arch piece 201 of the mold base 23 comprises a plurality of radial undulations 113 with continuity of tangency extending from a central zone 111 to the vicinity of a seat 108, i.e. extending in an arch 110, an undulation 113 being made up of a concave face 113a and a convex face 113b facing outward, the depth, that is the distance between the peak of a convexity and the trough of a concavity, of said undulations increasing from the central zone 111 to the vicinity of the seat 108.

Preferably, the mean radius of curvature of the concavities of the undulations is less than or equal to the mean radius of curvature of the convexities of the undulations 113.

Furthermore, the mean radius of curvature of the concavities 113a of the undulations is between 0.5 and 1.1 times the mean radius of curvature of the convexities 113b of the undulations, and preferably between 0.65 and 0.85 times the mean radius of curvature of the convexities 113b of the undulations 113.

In addition, the mean radius of curvature of the concavities 113a and/or of the convexities 113b of the undulations 113 is not constant along a radius of the base of the mold base 23, from the central zone 111 toward the periphery of the seat 108.

Preferably, the mold base 23 comprises between five and fifteen radial undulations 113 with continuity of tangency, and preferably between eight and ten radial undulations 113 with continuity of tangency.

Finally, it is obvious that the examples given above are merely particular illustrations that in no way limit the areas of application of the invention.

Therefore, at least the following is claimed:

1. A container made from plastic, the container comprising:
a body comprising a shoulder and a neck at an upper end; and
a base extending from a lower end of the body, the base comprising at least one peripheral heel defining a seat, and an arch that extends from a central zone to said heel, said heel rising up a connecting wall connecting with a wall of the body of the container,
wherein said base comprises a plurality of radial undulations extending from at least the central zone to the vicinity of the seat, wherein an undulation comprises a concave face and a convex face facing outward, a depth of said undulations increasing from the central zone to the vicinity of the seat, wherein the depth is a distance between the peak of a convexity and the trough of a concavity.

2. The container as claimed in claim 1, wherein the radial undulations have continuity of tangency.

3. The container as claimed in claim 1, wherein the radial undulations comprise at least one facet.

4. The container as claimed in claim 3, wherein each facet extends radially.

5. The container as claimed in claim 3, wherein each facet extends perpendicularly to a radius of the base.

6. The container as claimed in claim 1, wherein a mean radius of curvature of the concavities of the undulations is less than or equal to a mean radius of curvature of the convexities of the undulations.

7. The container as claimed in claim 6, wherein the mean radius of curvature of the concavities and/or of the convexities of the undulations is not constant along a radius of the base, from the central zone toward the seat.

8. The container as claimed in claim 1, wherein the base comprises between three and fifteen radial undulations.

9. The container as claimed in claim 1, wherein a height of the arch is between 0.15 and 0.35 times a diameter of the seat, wherein the height is the distance separating the seat from an upper end of the arch.

10. The container as claimed in claim 9, wherein the depth of an undulation in the seating plane is between 0.2 and 0.45 times the height of the arch.

11. The container as claimed in claim 1, wherein the depth of an undulation in the central zone is between 0.03 and 0.15 times the height of the arch.

12. The container as claimed in claim 1, wherein said undulations extend beyond the seat.

13. The container as claimed in claim 1, wherein an outer radius of curvature of the heel is between 0.7 and 0.2 times the seat diameter, wherein the outer radius of curvatures is between the seat and the connecting wall.

14. The container as claimed in claim 13, wherein an inner radius of curvature of the heel is between 0.6 and 1.4 times the outer radius of curvature of said heel, wherein the inner radius of curvature is between the distal end of the convex face of the undulations and the seat.

15. The container as claimed in claim 1, wherein a width of the seat is between 0.1 and 2 mm.

16. A mold base for manufacturing a container:
said mold base configured to be mounted at one end of a mold comprising two walls, wherein the two walls can be moved relative to each other to form the body of the container, said mold base comprising:
at least one first annular part configured to at least partially form the heel, and one of:
a second dome-shaped part configured to come into contact with an amorphous central zone of the preform to form an arch, or
a base ring and an arch piece that is inserted into said base ring,
wherein said second dome-shaped part or said arch piece of the mold base comprises a plurality of radial undulations extending from at least one central zone to the first annular part or to the base ring, the depth of said undulations increasing from the central zone to the periphery of the second part or to the base ring, wherein the depth is the distance between the peak of a convexity and a trough of a concavity.

17. The mold base as claimed in claim 16, wherein a mean radius of curvature of the concavities of the undulations is less than or equal to a mean radius of curvature of the convexities of the undulations.

18. The mold base as claimed in claim 17, wherein the mean radius of curvature of the concavities of the undulations is between 0.5 and 1.1 times the mean radius of curvature of the convexities of the undulations.

19. The mold base as claimed in claim 17, wherein the mean radius of curvature of the concavities and/or of the convexities of the undulations is not constant along a radius of the base of the mold base, from the central zone toward the periphery of the second part or toward the base ring.

20. The mold base as claimed in claim 16, wherein the mold base comprises between three and fifteen radial undulations with continuity of tangency.
